(19) United States
(12) Patent Application Publication
(10) Pub. No.: US 2017/0345411 A1
(43) Pub. Date: Nov. 30, 2017

(54) UNIT-SELECTION TEXT-TO-SPEECH SYNTHESIS BASED ON PREDICTED CONCATENATION PARAMETERS

(71) Applicant: Apple Inc., Cupertino, CA (US)

(72) Inventors: Tuomo J. RAITIO, Sunnyvale, CA (US); Kishore Sunkeswari PRAHALLAD, Cupertino, CA (US); Alistair D. CONKIE, Cupertino, CA (US); Ladan GOLIPOUR, Cupertino, CA (US); David A. WINARSKY, Cupertino, CA (US)

(21) Appl. No.: 15/266,930

(22) Filed: Sep. 15, 2016

Related U.S. Application Data
(60) Provisional application No. 62/341,948, filed on May 26, 2016.

(51) Int. Cl. G10L 13/10; G10L 13/06; G10L 13/033

(52) U.S. Cl. CPC G10L 13/10; G10L 13/0335; G10L 13/06

(57) ABSTRACT

Systems and processes for performing unit-selection text-to-speech synthesis are provided. In an example process, text to be converted to speech is received. The text is represented as a sequence of target units. A plurality of candidate speech segments corresponding to the sequence of target units are selected. Predicted statistical parameters of acoustic features associated with the sequence of target units are determined. The predicted statistical parameters of acoustic features are used to determine target costs and concatenation costs associated with the plurality of candidate speech segments. Based on a combined cost determined from the target costs and concatenation costs, a subset of candidate speech segments is selected from the plurality of candidate speech segments. Speech corresponding to the received text is generated using the subset of candidate speech segments.

### CROSS-REFERENCE TO RELATED APPLICATIONS

This application claims priority to U.S. Provisional Ser. No. 62/341,948, filed on May 26, 2016, entitled UNIT-SELECTION TEXT-TO-SPEECH SYNTHESIS BASED ON PREDICTED CONCATENATION PARAMETERS, which is hereby incorporated by reference in its entirety for all purposes.

### FIELD

The present disclosure relates generally to text-to-speech synthesis, and more specifically to techniques for performing unit-selection text-to-speech synthesis.

### BACKGROUND

Unit-selection text-to-speech (TTS) synthesis can be desirable for producing a more natural-sounding voice quality compared to other TTS methods. Conventionally, unit-selection TTS synthesis can include three stages: front-end text analysis, unit selection, and waveform synthesis. In the unit-selection stage, a unit-selection algorithm can be implemented to select a sequence of speech units (e.g., speech segments, phones, sub-phones, etc.) from a database of audio units. The speech units can be obtained by segmenting recordings of a voice talent's speech that represent the spoken form of a corpus of text. Implementing a sophisticated unit-selection algorithm can be desirable to select the most suitable speech units from the database. The most suitable audio units can have acoustic properties that best match the target pronunciation of the text to be converted to speech, which can enable the synthesis of high-quality, natural sounding speech.

### BRIEF SUMMARY

Systems and processes for performing unit-selection text-to-speech synthesis are provided. In one example process, text to be converted to speech is received. A sequence of target units representing a spoken pronunciation of the text is generated. Predicted statistical parameters for each of a plurality of acoustic features associated with each target unit of the sequence of target units are determined based on a plurality of linguistic features associated with each target unit. A plurality of candidate speech segments corresponding to the sequence of target units are selected based on the plurality of linguistic features associated with each target unit. A target cost for each candidate speech segment of the plurality of candidate speech segments is determined based on the predicted statistical parameters of a first acoustic feature of the plurality of acoustic features associated with a respective target unit of the sequence of target units. A plurality of concatenation costs with respect to a plurality of subsequent candidate speech segments are determined for each candidate speech segment of the plurality of candidate speech segments. The plurality of concatenation costs are determined based on the predicted statistical parameters of a second acoustic feature of the plurality of acoustic features associated with the respective target unit of the sequence of target units. A subset of candidate speech segments is selected from the plurality of candidate speech segments for speech synthesis. The subset of candidate speech segments is selected based on a combined cost associated with the subset of candidate speech segments. The combined cost is determined based on the target cost and the plurality of concatenation costs of each candidate speech segment. Speech corresponding to the received text is generated using the subset of candidate speech segments.

### BRIEF DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some examples.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIGS. 4A and 4B illustrate an exemplary user interface for a menu of applications on a portable multifunction device in accordance with some embodiments.

FIG. 5 illustrates an exemplary schematic block diagram of a text-to-speech module in accordance with some embodiments.

FIG. 6 illustrates an exemplary block diagram of a speech segment generation module in accordance with some embodiments.

FIG. 7 illustrates a flow diagram of an exemplary process for unit-selection text-to-speech synthesis in accordance with some embodiments.

FIG. 8 illustrates an exemplary sequence of target units with one or more candidate speech segments selected for each target unit in accordance with some embodiments.

FIG. 9 illustrates an exemplary mixture density network for determining predicted statistical parameters for acoustic features associated with a respective target unit in accordance with some embodiments.

FIG. 10 illustrates a flow diagram of an exemplary process for generating a database of speech segments used for unit-selection text-to-speech synthesis in accordance with some embodiments.

FIG. 11 illustrates a functional block diagram of an electronic device in accordance with some embodiments.

### DESCRIPTION OF EMBODIMENTS

In the following description of the disclosure and embodiments, reference is made to the accompanying drawings in which it is shown by way of illustration of specific embodiments that can be practiced. It is to be understood that other embodiments and examples can be practiced and changes can be made without departing from the scope of the disclosure.

In some conventional unit-selection text-to-speech synthesis processes, target costs are calculated for candidate speech segments to determine how well the actual acoustic features of the candidate speech segments match with the predicted acoustic features of the corresponding target units. Additionally, concatenation costs are calculated for every pair of consecutive candidate speech segments to determine how well each pair concatenates. For example, the concatenation costs indicate the differences in acoustic features between pairs of consecutive candidate speech segments. The candidate speech segments that result in the lowest combined cost based on the calculated target costs and concatenation costs are then selected for speech synthesis. Thus, in these conventional processes, pairs of consecutive candidate speech segments having the lowest concatenation costs tend to be selected for speech synthesis. However, in natural speech, there can be inherent differences in the acoustic features between pairs of consecutive speech segments. For example, the pitch between a pair of consecutive speech segments can be rising or falling at a particular rate, which results in an inherent difference in pitch between the speech segments. Minimizing these differences by selecting consecutive pairs of candidate speech segments having the lowest concatenation costs for speech synthesis may thus result in less natural sounding speech. In accordance with exemplary systems and processes described herein, it may be desirable to compare the actual differences in acoustic features between consecutive pairs of candidate speech segments with the predicted differences in acoustic features associated with the corresponding target units.

In one example process for unit-selection text-to-speech synthesis, text to be converted to speech is received. A sequence of target units representing a spoken pronunciation of the text is generated. Predicted statistical parameters for each of a plurality of acoustic features associated with each target unit of the sequence of target units are determined based on a plurality of linguistic features associated with each target unit. A plurality of candidate speech segments corresponding to the sequence of target units are selected based on the plurality of linguistic features associated with each target unit. A target cost for each candidate speech segment of the plurality of candidate speech segments is determined based on the predicted statistical parameters of a first acoustic feature of the plurality of acoustic features associated with a respective target unit of the sequence of target units. A plurality of concatenation costs with respect to a plurality of subsequent candidate speech segments are determined for each candidate speech segment of the plurality of candidate speech segments. The plurality of concatenation costs are determined based on the predicted statistical parameters of a second acoustic feature of the plurality of acoustic features associated with the respective target unit of the sequence of target units. In some examples, the predicted statistical parameters of the second acoustic feature represent the predicted difference of the first acoustic feature between the respective target unit and the subsequent target unit. In these examples, the concatenation cost represents a comparison of the actual differences in acoustic features between consecutive pairs of candidate speech segments with the predicted differences in acoustic features between corresponding target units. A subset of candidate speech segments is selected from the plurality of candidate speech segments for speech synthesis. The subset of candidate speech segments is selected based on a combined cost associated with the subset of candidate speech segments. The combined cost is determined based on the target cost and the plurality of concatenation costs of each candidate speech segment. Speech corresponding to the received text is generated using the subset of candidate speech segments.

Although the following description uses terms first, second, etc. to describe various elements, these elements should not be limited by the terms. These terms are only used to distinguish one element from another. For example, a first candidate speech segment could be termed a second candidate speech segment, and, similarly, a second candidate speech segment contact could be termed a first candidate speech segment, without departing from the scope of the present invention. The first candidate speech segment and the candidate speech segment contact are both candidate speech segment, but they are not the same candidate speech segment.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, systems for providing embedded phrases on such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable devices, such as laptops or tablet computers with touch-sensitive surfaces (e.g., touch screen displays and/or touch pads), may also be used. Exemplary embodiments of laptop and tablet computers include, without limitation, the iPad® and MacBook® devices from Apple Inc. of Cupertino, Calif. It should also be understood that, in some embodiments, the device is not a portable communications device, but is a desktop computer. Exemplary embodiments of desktop computers include, without limitation, the Mac Pro® from Apple Inc. of Cupertino, Calif.

In the discussion that follows, an electronic device that includes a display and a touch-sensitive surface is described. It should be understood, however, that the electronic device optionally includes one or more other physical user-interface devices, such as button(s), a physical keyboard, a mouse, and/or a joystick.

The device may support a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

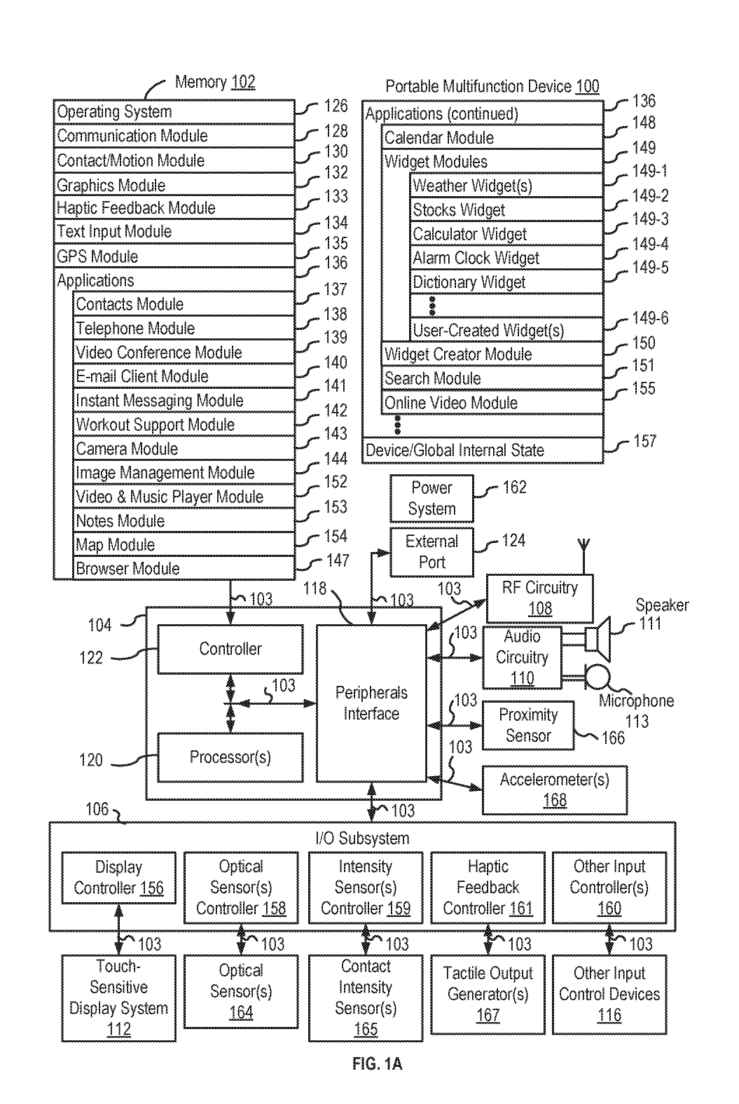

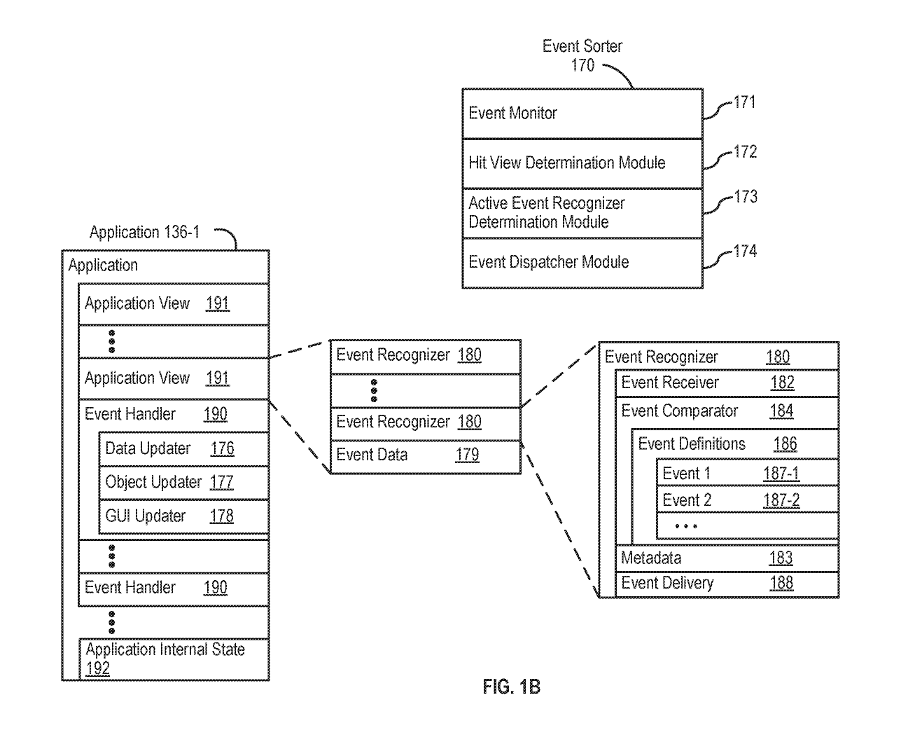

FIGS. 1A and 1B are block diagrams illustrating exemplary portable multifunction device 100 with touch-sensitive displays 112 in accordance with some embodiments. Touch-sensitive display 112 is sometimes called a “touch screen” for convenience. Device 100 includes memory 102. Device 100 includes memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 includes one or more optical sensors 164. Bus/signal lines 103 allows these components to communicate with one another. Device 100 is one example of an electronic device that could be used to perform the techniques described herein. Specific implementations involving device 100 may have more or fewer components than shown, may combine two or more components, or may have a different configuration or arrangement of the components. The various components shown in FIGS. 1A and 1B may be implemented in hardware, software, or a combination of both. The components also can be implemented using one or more signal processing and/or application specific integrated circuits.

Memory 102 includes one or more computer readable storage mediums. The computer readable storage mediums may be tangible and non-transitory. The computer-readable storage mediums are optionally transitory. Memory 102 may include high-speed random access memory and may also include non-volatile memory, such as one or more magnetic disk storage devices, flash memory devices, or other non-volatile solid-state memory devices. Memory controller 122 may control access to memory 102 by other components of device 100.

Peripherals interface 118 is used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 is implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 502.11a, IEEE 502.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

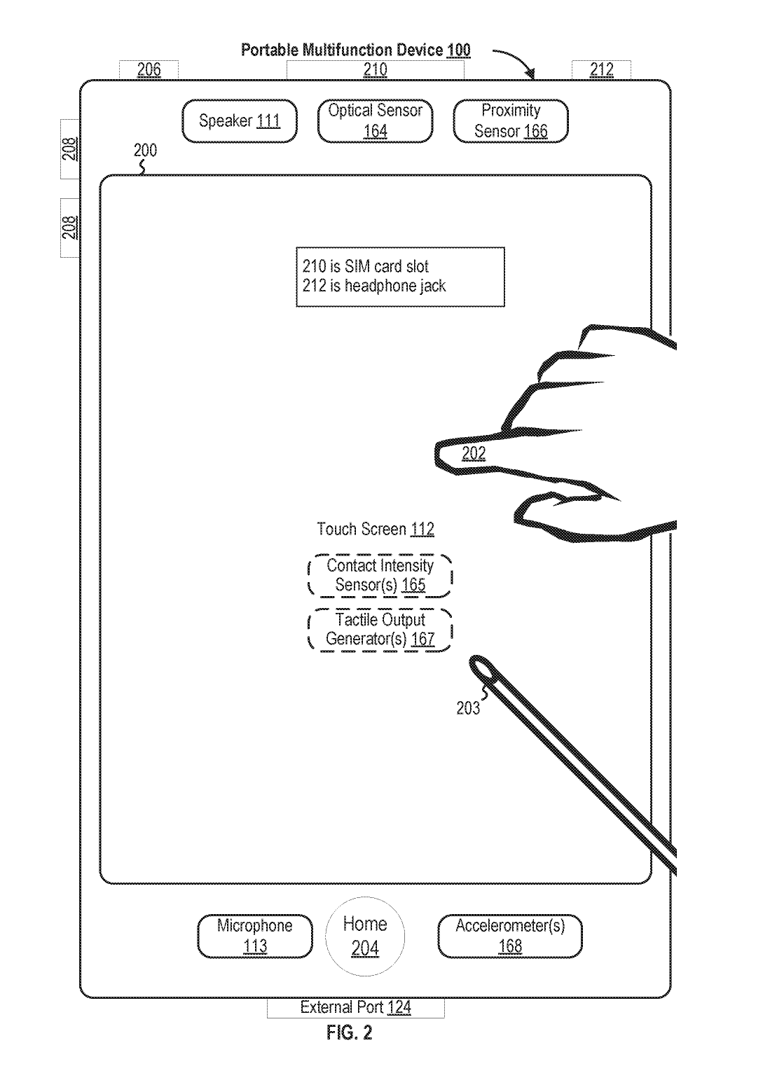

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 includes display controller 156 and one or more input controllers 160 for other input or control devices. The one or more input controllers 160 receive/send electrical signals from/to other input or control devices 116. The other input control devices 116 include physical buttons (e.g., push buttons, rocker buttons, etc.), dials, slider switches, joysticks, click wheels, and so forth. In some alternate embodiments, input controller(s) 160 is coupled to any (or none) of the following: a keyboard, infrared port, USB port, and a pointer device such as a mouse. The one or more buttons (e.g., 208, FIG. 2) include an up/down button for volume control of speaker 111 and/or microphone 113. The one or more buttons may include a push button (e.g., 206, FIG. 2). A quick press of the push button disengages a lock of touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) turns power to device 100 on or off. The user may be able to customize a functionality of one or more of the buttons. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web-pages or images) that are displayed on touch screen 112. In an exemplary embodiment, a point of contact between touch screen 112 and the user corresponds to a finger of the user.

In some examples, touch screen 112 uses LCD (liquid crystal display) technology, LPD (light emitting polymer display) technology, or LED (light emitting diode) technology, although other display technologies may be used in other embodiments. Touch screen 112 and display controller 156 detects contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 may be analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch sensitive touchpads do not provide visual output.

A touch-sensitive display in some embodiments of touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

In some examples, touch screen 112 has a video resolution in excess of 100 dpi. In some embodiments, the touch screen has a video resolution of approximately 160 dpi. The user can make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 112 or an extension of the touch-sensitive surface formed by the touch screen.

Device 100 also includes power system 162 for powering the various components. Power system 162 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 also includes one or more optical sensors 164. FIGS. 1A and 1B show an optical sensor coupled to optical sensor controller 158 in I/O subsystem 106. Optical sensor 164 includes charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 captures still images or video. In some embodiments, an optical sensor is located on the back of device 100, opposite touch screen display 112 on the front of the device, so that the touch screen display may be used as a viewfinder for still and/or video image acquisition. In some embodiments, an optical sensor is located on the front of the device so that the user's image may be obtained for videoconferencing while the user views the other video conference participants on the touch screen display. In some embodiments, the position of optical sensor 164 can be changed by the user (e.g., by rotating the lens and the sensor in the device housing) so that a single optical sensor 164 may be used along with the touch screen display for both video conferencing and still and/or video image acquisition.

In some examples, device 100 also includes one or more proximity sensors 166. FIGS. 1A and 1B show proximity sensor 166 coupled to peripherals interface 118. Alternately, proximity sensor 166 is coupled to input controller 160 in I/O subsystem 106. Proximity sensor 166 may perform as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 also includes one or more accelerometers 168. FIGS. 1A and 1B show accelerometer 168 coupled to peripherals interface 118. Alternately, accelerometer 168 is coupled to an input controller 160 in I/O subsystem 106. Accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

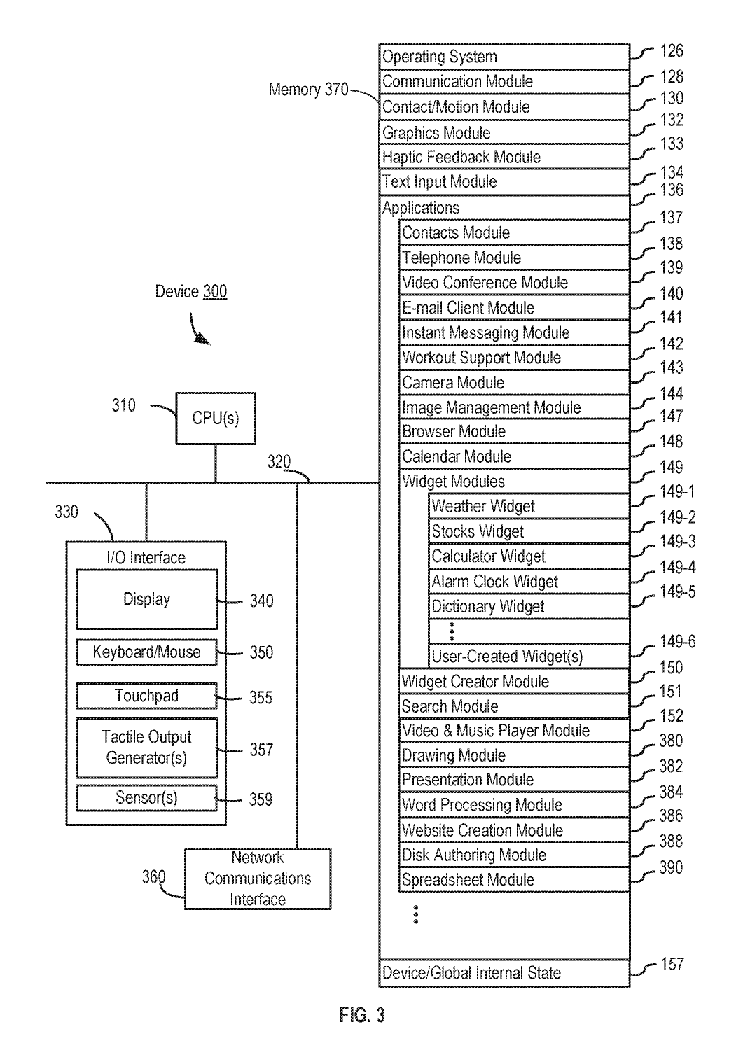

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. 1A, 1B and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin connector that is the same as, or similar to and/or compatible with the 5-pin and/or 30-pin connectors used on devices made by Apple Inc.

Contact/motion module 130 detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, contact/motion module 130 and display controller 156 detects contact on a touchpad. In some embodiments, contact/motion module 130 and controller 160 detects contact on a click wheel.

Contact/motion module 130 detects a gesture input by a user. Different gestures on the touch-sensitive surface have different contact patterns. Thus, a gesture is detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the intensity of graphics that are displayed. As used herein, the term “graphics” includes any object that can be displayed to a user, including without limitation text, web-pages, icons (such as user-interface objects including soft keys), digital images, videos, animations and the like. In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 include the following modules (or sets of instructions), or a subset or superset thereof:
Contacts module 137 (sometimes called an address book or contact list);
Telephone module 138;
Video conferencing module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 is used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 is used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with touch screen 112, display controller 156, contact/motion module 130, graphics module 132, audio circuitry 110, and speaker 111, video player module 145 includes executable instructions to display, present or otherwise play back videos (e.g., on touch screen 112 or on an external, connected display via external port 124).

In conjunction with touch screen 112, display system controller 156, contact module 130, graphics module 132, audio circuitry 110, speaker 111, RF circuitry 108, and browser module 147, music player module 146 includes executable instructions that allow the user to download and play back recorded music and other sound files stored in one or more file formats, such as MP3 or AAC files. In some embodiments, device 100 includes the functionality of an MP3 player, such as an iPod (trademark of Apple Inc.).

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web-pages or portions thereof, as well as attachments and other files linked to web-pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 is used by a user to create widgets (e.g., turning a user-specified portion of a web-page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 is used to receive, display, modify, and store maps and data associated with maps (e.g., driving directions; data on stores and other points of interest at or near a particular location; and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged in various embodiments. For example, video player module may be combined with music player module into a single module (e.g., video and music player module 152, FIG. 1B). In some embodiments, memory 102 stores a subset of the modules and data structures identified above. Furthermore, memory 102 stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that may be performed exclusively through a touch screen and/or a touchpad include navigation between user interfaces. In some embodiments, the touchpad, when touched by the user, navigates device 100 to a main, home, or root menu from any user interface that may be displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is(are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration). In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 187 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen displays one or more graphics within user interface (UI) 200. In this embodiment, as well as others described below, a user selects one or more of the graphics by making contact or touching the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 also includes one or more physical buttons, such as “home” or menu button 204. As described previously, menu button 204 is used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 includes circuitry (sometimes called a chipset) that interconnects and controls communications between system components. Device 300 includes input/output (I/O) interface 330 comprising display 340, which is typically a touch screen display. I/O interface 330 also includes a keyboard and/or mouse (or other pointing device) 350 and touchpad 355. Memory 370 includes high-speed random access memory, such as DRAM, SRAM, DDR RAM or other random access solid state memory devices; and includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1), or a subset thereof. Furthermore, memory 370 stores additional programs, modules, and data structures not present in memory 102 of portable multifunction device 100. For example, memory 370 of device 300 stores drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 can be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 stores a subset of the modules and data structures identified above. Furthermore, memory 370 stores additional modules and data structures not described above.

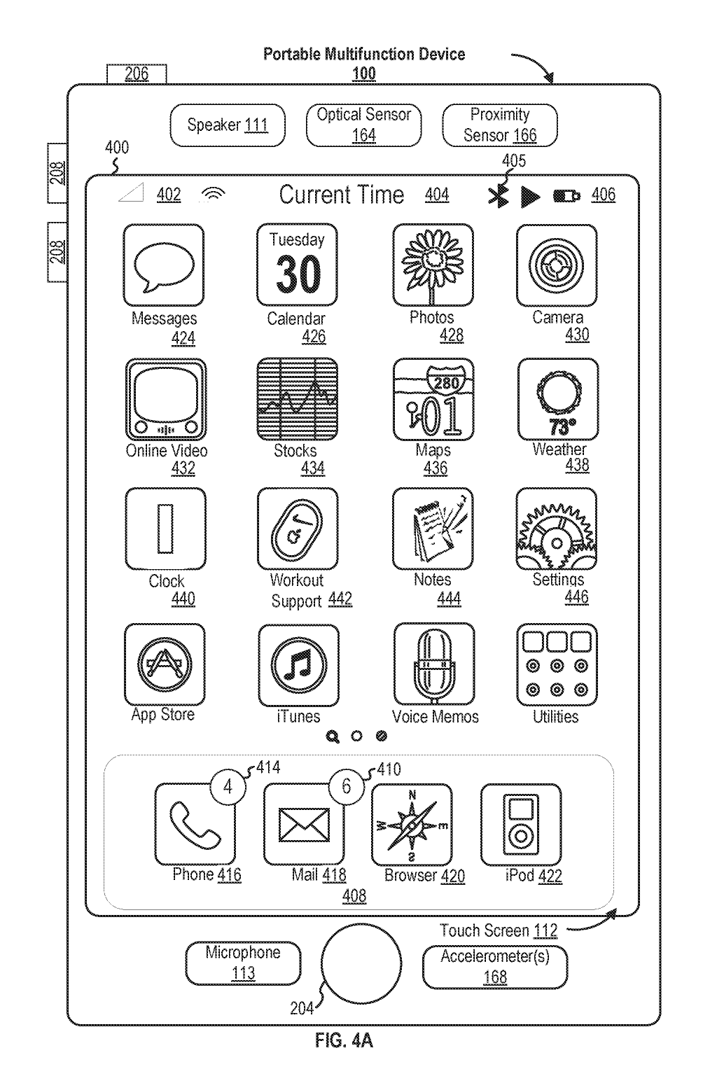

Attention is now directed towards embodiments of user interfaces (“UI”) that may be implemented on portable multifunction device 100. FIG. 4A illustrates exemplary user interfaces for a menu of applications on portable multifunction device 100 in accordance with some embodiments. Similar user interfaces may be implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Although many of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451) has a primary axis (e.g., 452) that corresponds to a primary axis (e.g., 453) on the display (e.g., 450). In accordance with these embodiments, the device detects contacts (e.g., 460 and 462) with the touch-sensitive surface 451 at locations that correspond to respective locations on the display (e.g., 460 corresponds to 468 and 462 corresponds to 470). In this way, user inputs (e.g., contacts 460 and 462, and movements thereof) detected by the device on the touch-sensitive surface (e.g., 451) are used by the device to manipulate the user interface on the display (e.g., 450) of the multifunction device when the touch-sensitive surface is separate from the display. It should be understood that similar methods may be used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used in the specification and claims, the term “open application” refers to a software application with retained state information (e.g., as part of device/global internal state 157 and/or application internal state 192). An open (e.g., executing) application is any one of the following types of applications:
an active application, which is currently displayed on display 112 (or a corresponding application view is currently displayed on the display);
a background application (or background process), which is not currently displayed on display 112, but one or more application processes (e.g., instructions) for the corresponding application are being processed by one or more processors 120 (i.e., running);
a suspended application, which is not currently running, and the application is stored in a volatile memory (e.g., DRAM, SRAM, DDR RAM, or other volatile random access solid state memory device of memory 102); and
a hibernated application, which is not running, and the application is stored in a non-volatile memory (e.g., one or more magnetic disk storage devices, optical disk storage devices, flash memory devices, or other non-volatile solid state storage devices of memory 102).

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

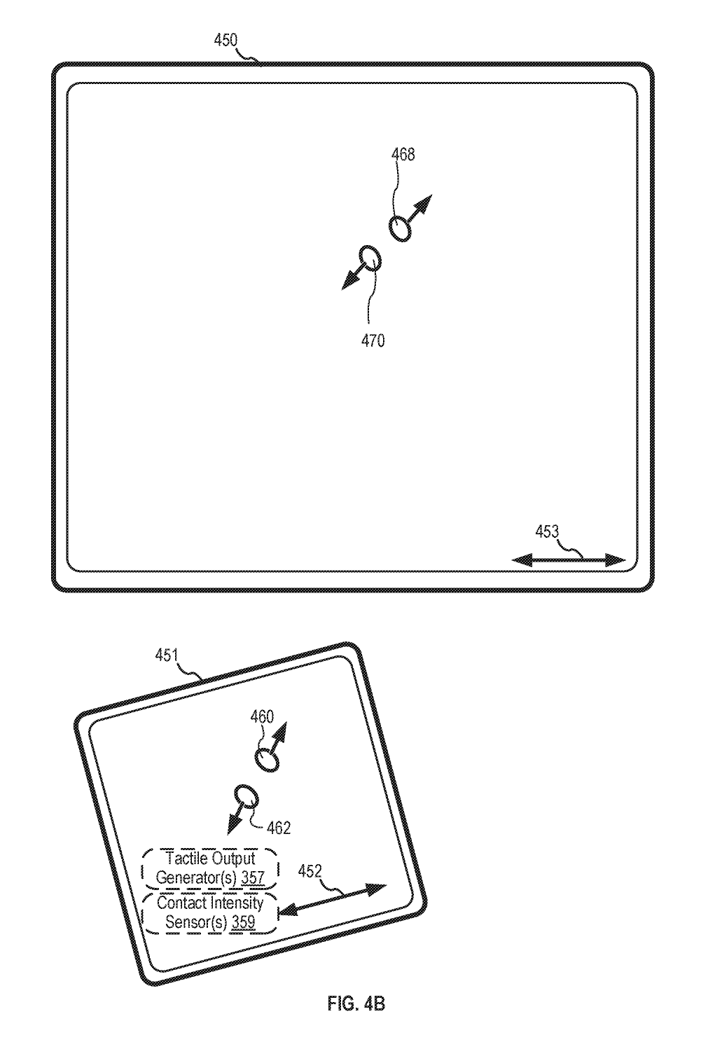

FIG. 5 illustrates an exemplary schematic block diagram of text-to-speech module 500 in accordance with some embodiments. In some embodiments, text-to-speech module 500 is implemented using one or more multifunction devices including but not limited to devices 100, 400, and 1100 (FIGS. 1A, 2, 4A-B, and 11). In particular, memory 102 (FIG. 1A) or 370 (FIG. 3) can include text-to-speech module 500. Text-to-speech module 500 can enable speech synthesis capabilities in a multifunctional device. Specifically, text-to-speech module 500 can enable a multifunctional device to perform the unit-selection text-to-speech synthesis processes (e.g., process 700) described herein.

As shown in FIG. 5, text-to-speech module 500 is configured to receive text to be converted to speech and output a speech waveform corresponding to the spoken form of the received text. The text is received by text analysis module 502 of text-to-speech module 500. Text analysis module 502 is configured to convert the text into a sequence of target units representing the spoken pronunciation of the text. Notably, each target unit is not an actual speech unit. Rather each target unit is the linguistic specification of the desired unit according to the received text. The desired unit is a theoretical phonetic unit, such as a phone, diphone, half-phone, or the like. Each target unit specifies linguistic features (e.g., speech segment position, syllables, syllabic stress, syllable position, phrase length, part of speech, word prominence, context, etc.) that correspond to the text. In some examples, text analysis module 502 applies orthographic rules and grammar rules to convert the text into the sequence of target units. In other examples, text analysis module 502 includes a lexicon where words in text form are mapped to their corresponding target units. The sequence of target units with corresponding linguistic features is forwarded to unit-selection module 504.

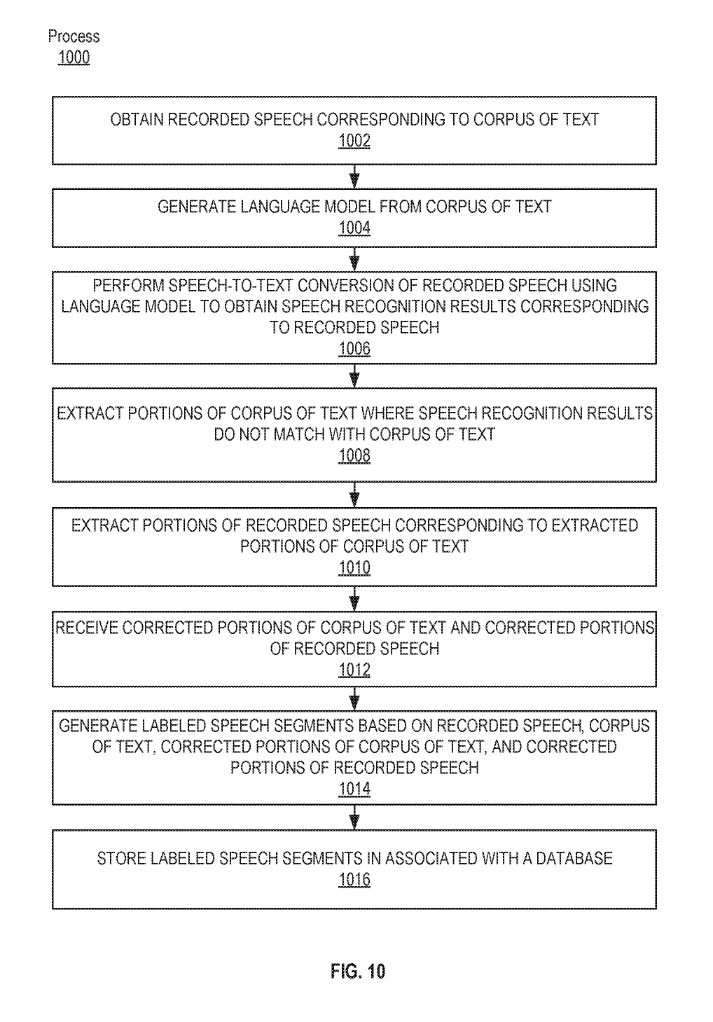

Speech segment database 508 includes a plurality of speech segments derived from recorded speech and a corresponding corpus of text. Each speech segment includes linguistic features and acoustic features (e.g., spectral shape, pitch, duration, Mel-frequency cepstral coefficients, fundamental frequency, etc.). The plurality of speech segments are indexed and stored in speech segment database 508 according to the linguistic features and acoustic features. The speech segments of speech segment database 508 are generated, for example, using process 1000 described below with reference to FIG. 10.

Unit-selection module 504 is configured to pre-select suitable speech segments from speech segment database 508 that best match the sequence of target units. In particular, unit-selection module 504 is configured to pre-select one or more candidate speech segments from speech segment database 508 for each target unit of the sequence of target units. The pre-selection is based on a determined cost that indicates how well the linguistic features of a particular candidate speech segment match with the linguistic features of the respective target unit.

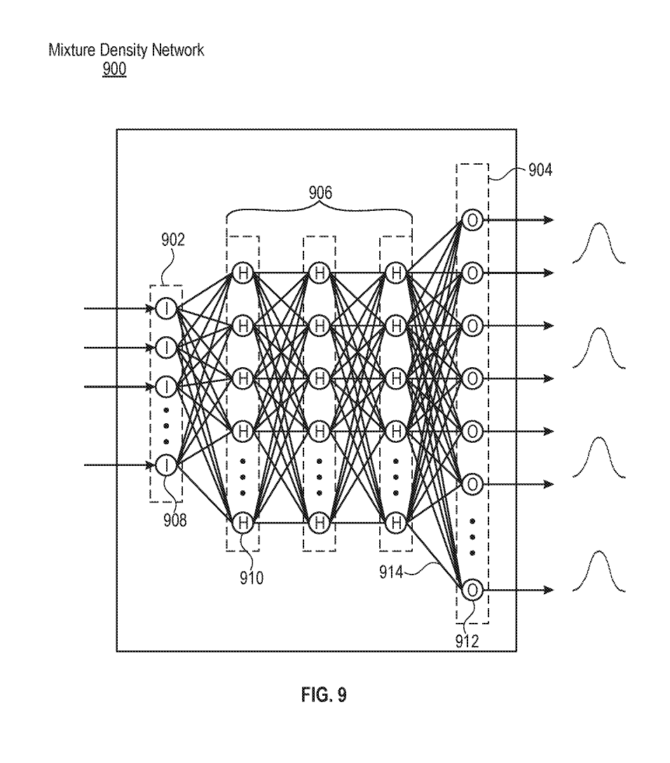

Using one or more statistical models stored in acoustic feature prediction model(s) 506, unit-selection module 504 is configured to determine predicted statistical parameters of acoustic features for each target unit of the sequence of target units. The predicted statistical parameters include, for example, the means, variances, or density weights of the acoustic features. The one or more statistical models are trained using recorded speech and a corresponding corpus of text. In some examples, the one or more statistical models include a mixture density network (e.g., mixture density network 900 of FIG. 9, described below). The linguistic features of a target unit are used to determine the predicted statistical parameters of acoustic features for the target unit. For example, the one or more statistical models receive the linguistic features of a target unit and determine corresponding predicted statistical parameters of the acoustic features for the target unit.

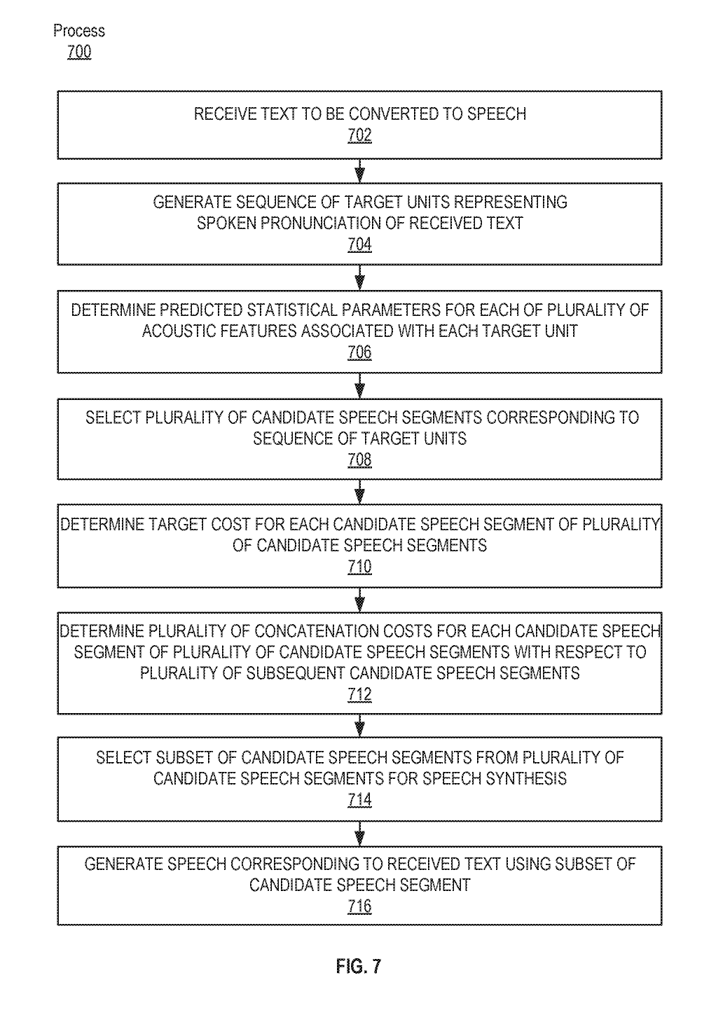

Unit-selection module 504 is configured to determine a target cost for a pre-selected candidate speech segment based on the predicted statistical parameters of a first acoustic feature of the acoustic features associated with the respective target unit. For example, as discussed in greater detail below with respect to block 710 of FIG. 7, the target cost is based on the weighted difference between the actual acoustic features of the pre-selected candidate speech segment and the predicted statistical parameters of the first acoustic feature associated with the respective target unit. Unit-selection module 504 is further configured to determine, for a pre-selected candidate speech segment, a plurality of concatenation costs with respect to a plurality of subsequent pre-selected candidate speech segments. In particular, the plurality of concatenation costs are determined based on the predicted statistical parameters of a second acoustic feature of the acoustic features associated with the respective target unit. As discussed in greater detail below with respect to block 712 of FIG. 7, the concatenation cost is based on the weighted difference between the actual acoustic features of the pre-selected candidate speech segment and the predicted statistical parameters of the second acoustic feature associated with the respective target unit.

Unit-selection module 504 is configured to select from the pre-selected candidate speech segments a subset of pre-selected candidate speech segments for speech synthesis. The selecting is based on a combined cost associated with the subset. The combined cost is determined based on the target cost and the plurality of concatenation costs of each pre-selected candidate speech segment. For example, unit-selection module 504 is configured to perform a Viterbi search through the pre-selected candidate speech segments to determine the subset of pre-selected candidate speech segments having the lowest combined cost. The selected subset is then used to synthesize speech corresponding to the received text.

Speech synthesizer module 510 is configured to receive the selected subset of pre-selected candidate speech segments from unit-selection module 504 and join the sequence of speech segments into a continuous speech waveform. Speech synthesizer module 510 is further configured to apply various signal processing algorithms to smooth out the acoustic features between speech segments to generate a smooth, continuous speech waveform. The speech waveform is an audio rendering of the spoken form of the text received at text analysis module 502. In particular, the speech waveform is in the form of an audio signal or audio data file (e.g., .wav, .mp3, .wma, etc.).

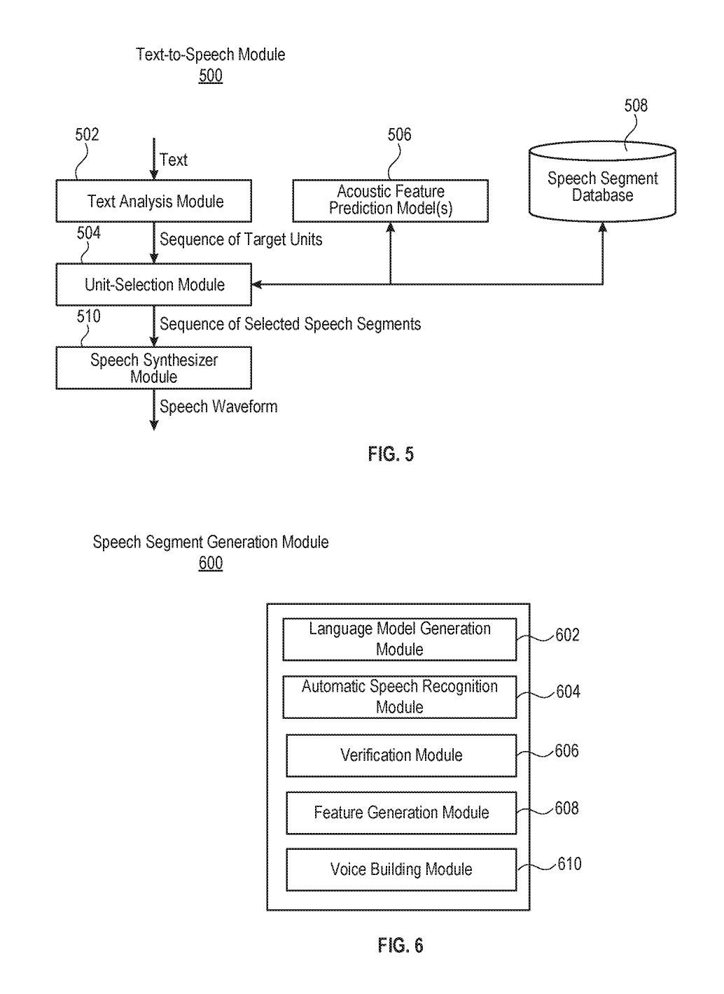

FIG. 6 illustrates an exemplary block diagram of speech segment generation module 600 in accordance with some embodiments. In some embodiments, speech segment generation module 600 is implemented using one or more multifunction devices including but not limited to devices 100, 400, and 1100 (FIGS. 1A, 2, 4A-B, and 11). In particular, memory 102 (FIG. 1A) or 370 (FIG. 3) includes speech segment generation module 600. As shown in FIG. 6, speech segment generation module 600 includes language model generation module 602, automatic speech recognition module 604, verification module 606, feature generation module 608, and voice building module 610. Speech segment generation module 600 can enable the generation of speech segments for a speech segment database (e.g., speech segment database 508) in a multifunctional device. Specifically, speech segment generation module 600 is used to perform process 1000 for generating a database of speech segments for use in unit-selection text-to-speech synthesis, described below.

Language model generation module 602 is configured to receive a corpus of text and generate a language model. The generated language model is configured to predict a current word given a context of previous words. For example, the generated language model is an n-gram language model. In some examples, the generate language model is a statistical language model or a neural network based language model.

Automatic speech recognition module 604 is configured to receive speech input and generate speech recognition results corresponding to the speech input. In particular, the speech recognition results include text corresponding to the speech input. Automatic speech recognition module 604 includes a front-end speech pre-processor for extracting representative features from the speech input. For example, the front-end speech pre-processor can perform a Fourier transform on the speech input to extract spectral features that characterize the speech input as a sequence of representative multi-dimensional vectors. Further, automatic speech recognition module 604 includes one or more speech recognition models (e.g., acoustic models and/or language models) and can implement one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, speech recognition results (e.g., words, word strings, or sequence of tokens).

Verification module 606 is configured to compare the speech recognition results (e.g., from automatic speech recognition module 604) with a reference corpus of text to identify any mismatches. Verification module 606 is configured to extract out the portions of the reference corpus of text where the speech recognition results do not match the reference corpus of text. Further, verification module 606 is configured to extract out portions of recorded speech corresponding to the extracted portions of the reference corpus of text. Verification module 606 then sends out the portions of the reference corpus of text and the corresponding portions of recorded speech to be verified and/or corrected by a separate verification service (e.g., a crowdsourcing service). Verification module 606 is further configured to receive corrected portions of speech recognition results and corrected portions of recorded speech from the separate verification service. Verification module 606 generates verified recorded speech and a verified corpus of text by modifying the recorded speech and/or the reference corpus of text based on the received corrected portions of the corpus of text and corrected portions of recorded speech.

Returning back to automatic speech recognition module 604, automatic speech recognition module 604 is configured to process the verified recorded speech from verification module 606. The verified recorded speech is separated into a plurality of speech segments (e.g., phones or sub-phones). Automatic speech recognition module 604 further processes the verified corpus of text of the recorded speech to force-align the verified recorded speech to the verified corpus of text. Each speech segment thus corresponds to an aligned portion of the corpus of text.

Feature generation module 608 is configured to analyze each speech segment of the verified recorded speech to determine the acoustic features associated with the respective speech segment. For example, spectral shape, pitch, duration, Mel-frequency cepstral coefficients, fundamental frequency, or the like can be determine for each speech segment. In particular, feature generation module 608 is configured to determine the fundamental frequency of a speech segment. For example, several fundamental frequency estimation methods known in the art can be implemented in a voting scheme that forms a robust fundamental frequency curve. The fundamental frequency curve is then used in pitch marking to derive the pseudo-glottal closure instant locations. The fundamental frequency of a speech segment is determined based on the derived pseudo-glottal closure instant locations.

Voice building module 610 is configured to generate labeled speech segments. In particular, each speech segment generated from the verified recorded speech is labeled to indicate the linguistic features and acoustic features of the speech segment. The labeled speech segments are stored in an indexed speech segment database (e.g., speech segment database 508). The labeled speech segments are thus searched and retrieved based on their identity (e.g., the specific phone or sub-phone), their linguistic features, or their acoustic features.

FIG. 7 illustrates a flow diagram of an exemplary process 700 for unit-selection text-to-speech synthesis in accordance with some embodiments. Process 700 can be performed using one or more of devices 100, 300, and 1100 (FIGS. 1A, 2, 3A-B, and 11). In particular, process 700 can be performed using a text-to-speech module (e.g., text-to-speech module 500 of FIG. 5), implemented on the one or more devices. It should be appreciated that some operations in process 700 can be combined, the order of some operations can be changed, and some operations can be omitted.

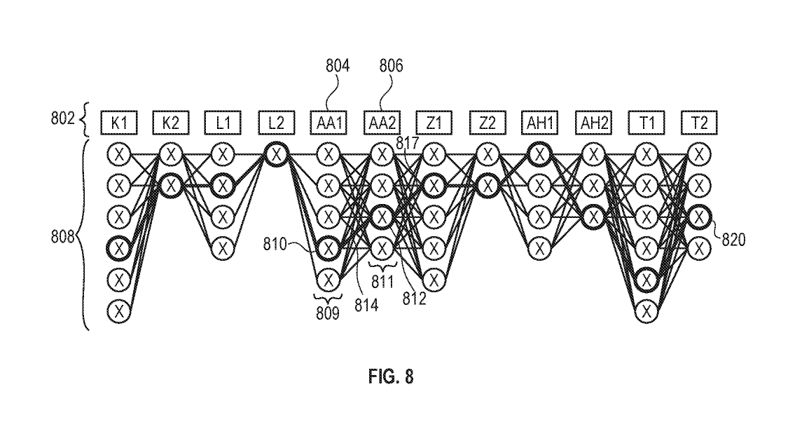

At block 702, text to be converted to speech is received. In some examples, the text is received via user input (e.g., from a keyboard, touch screen, etc.). In other examples, the text is received from a digital assistant implemented on the electronic device. In particular, the digital assistant generates a text response to satisfy a user request. The text response is received from a remote digital assistant server or a local client digital assistant module. In yet other examples, the text is received from an application (e.g., application 136) of the electronic device. The text is in the form of a sequence of tokens representing the text. In an illustrative example shown in FIG. 8, the received text includes the word “closet.”

At block 704, a sequence of target units representing a spoken pronunciation of the text is generated. The sequence of target units is generated using a text analysis module (e.g., text analysis module 502) of the device. In particular, the text is converted to the sequence of target units. The sequence of target units is a phonetic transcription or a phonemic transcription of the text. In the context of the present disclosure, “target units” are not actual speech units. Rather, the sequence of target units specifies a plurality of phonetic units that are arranged in an order consistent with the text. The sequence of target units thus represents the linguistic specifications of the desired units according to the text. Each target unit in the sequence of target units specifies linguistic features (also referred to as text features) corresponding to the respective portion of the text. In particular, the linguistic features include context (e.g., phone position, syllable position, phrase length, part of speech, etc.) extracted from the text. The linguistic features are extracted from the text by applying a set of predetermined rules, using a linguistic feature model, or using a database that can map words of the text to corresponding linguistic features. It should be recognized that the text may be pre-processed (e.g., cleaned and normalized) prior to converting the text to the sequence of target units.

In one example, depicted in FIG. 8, the text “closet” is converted to sequence of target units 802 “K1-K2-L1-L2-AA1-AA2-Z1-Z2-AH1-AH2-T1-T2,” where each target unit specifies a respective half-phone according to the text. Further, each target unit specifies linguistic features that are extracted from the text “closet.” In this example, sequence of target units 802 includes first target unit 804 (e.g., AA1) and second target unit 806 (e.g., AA2). First target unit 804 precedes second target unit 806 in sequence of target units 802. In particular, first target unit 804 and second target unit 806 are consecutive target units where first target unit 804 immediately precedes second target unit 806 and no other target unit is disposed between first target unit 804 and second target unit 806. The sequence of target units is represented mathematically as T={t₁, t₂, . . . t_{N}}, where each target unit, tₙ, is a vector of the linguistic features corresponding to the respective target unit. Thus, in the present example, first target unit 804 is represented as the linguistic feature vector t₅ and second target unit 806 is represented as the linguistic feature vector t₆. The linguistic feature vector of a target unit includes, for example, the 1-of-N coding of each half-phone, additional syllable, word, and sentence/phrase level features, and prominence/stress features. In a specific example, the length of each linguistic feature vector is 233.

At block 706, predicted statistical parameters for each of a plurality of acoustic features associated with each target unit in the sequence of target units are determined. In particular, a trained statistical model is used to determine, based on the linguistic features corresponding to a target unit in the sequence of target units, the predicted statistical parameters for each of the plurality of acoustic features associated with the target unit. The statistical model is generated (e.g., trained) using recorded speech and a corresponding corpus of text. In some examples, the statistical model is configured to receive, as inputs, the linguistic features of a respective target unit (e.g., linguistic feature vector t₅ of first target unit 804). Based on the inputted linguistic features, the statistical model is configured to output the predicted statistical parameters for each of the plurality of acoustic features associated with the respective target unit (e.g., first target unit 804). Blocks 706-714 can be performed using a unit-selection module (e.g., unit-selection module 504) of the device.

In some examples, the predicted statistical parameters include a mean parameter for each of the plurality of acoustic features and a variance parameter for each of the plurality of acoustic features. Further, in some examples, the predicted statistical parameters include one or more density weights for each of the plurality of acoustic features associated with the respective target unit. In some examples, the plurality of acoustic features include Mel-frequency cepstral coefficients, fundamental frequency, pitch, or duration of the respective target unit. The plurality of acoustic features further include one or more acoustic features each representing a change (e.g., delta) in an acoustic feature. For example, the plurality of acoustic features include a second acoustic feature (e.g., delta fundamental frequency or delta mel-frequency cepstral coefficient) that represents a change in the first acoustic feature (e.g., fundamental frequency or mel-frequency cepstral coefficient) of the respective target unit. In some examples, the change in an acoustic feature is a slope of the acoustic feature. For example, the plurality of acoustic features include a slope of the pitch at the beginning or end of the respective target unit.

In some examples, any one of the plurality of acoustic features can correspond to a specific portion of the respective target unit. For example, one or more acoustic features of the plurality of acoustic features correspond to the beginning, the middle, or the end of the respective target unit. Thus, in one example, an acoustic feature of the plurality of acoustic features is the fundamental frequency at the beginning of the respective target unit, another acoustic feature of the plurality of acoustic features is the fundamental frequency at the middle of the respective target unit, and yet another acoustic feature of the plurality of acoustic features is the fundamental frequency at the end of the respective target unit. In another example, the plurality of acoustic features include a first plurality of mel-frequency cepstral coefficients at a beginning of the respective target unit, a second plurality of mel-frequency cepstral coefficients at a middle of the respective target unit, and a third plurality of mel-frequency cepstral coefficients at an end of the respective target unit. In yet another example, an acoustic feature of the plurality of acoustic features is the change in fundamental frequency at the end of the respective target unit or a change in the mel-frequency cepstral coefficient at the end of the respective target unit.

Acoustic features that represent a change in certain acoustic features (e.g., delta fundamental frequency or delta mel-frequency cepstral coefficients) can be desirable for predicting concatenation. For example, the predicted delta fundamental frequency at the end of first target unit 804 indicates whether the pitch at the end of this target unit is expected to go up or down and by how much. This information is then used to select (e.g., at block 714) a suitable pair of candidate speech units (e.g., first candidate speech unit 810 and second candidate speech unit 812) that concatenate in the expected manner. This can improve the accuracy and naturalness of the resultant synthesized speech as compared to methods where the difference in acoustic features between pairs of candidate speech segments are merely minimized without referencing a predicted concatenation parameter.

In some examples, the statistical model is a deep neural network composed by a mixture of probability distributions. In particular, the statistical model is a mixture density network or a recurrent mixture density network. With reference to FIG. 9, exemplary mixture density network 900 for determining predicted statistical parameters for each of a plurality of acoustic features associated with a respective target unit in the sequence of target units is depicted. Mixture density network 900 includes multiple layers. In particular, mixture density network 900 includes input layer 902, output layer 904, and one or more hidden layers 906 disposed between input layer 902 and output layer 904. In this example, mixture density network 900 includes three hidden layers 906. It should be recognized, however, that in other examples, mixture density network 900 can include any number of hidden layers 906.

Each layer of mixture density network 900 includes multiple units. The units are the basic computational elements of mixture density network 900 and are referred to as dimensions, neurons, or nodes. As shown in FIG. 9, input layer 902 includes input units 908, hidden layers 906 include hidden units 910, and output layer 904 includes output units 912. Hidden layers 906 each include any number of hidden units 910. In a specific example, hidden layers 906 each include 512 hidden units 910. The units are interconnected by connections 914. Specifically, connections 914 connect the units of one layer to the units of a subsequent layer. Further, each connection 914 is associated with a weighting value and a bias followed by a nonlinear activation function. For simplicity, the weighting values and biases are not shown in FIG. 9.

Input layer 902 is configured to receive the linguistic features (e.g., linguistic feature vector tₙ) associated with the respective target unit. The number of input units 908 in input layer 902 corresponds to the length of the linguistic feature vector of the respective target unit. Each input unit is configured to process a specific linguistic feature represented in the linguistic feature vector. In a specific example, input layer 902 includes 233 input units 908 to receive a linguistic feature vector having a length of 233.

Output layer 904 is configured to output the predicted statistical parameters for each of the plurality of acoustic features associated with the respective target unit. In particular, the outputted predicted statistical parameters for each of the plurality of acoustic features correspond to the linguistic features of the respective target unit received at input layer 902. For example, output layer 904 outputs the predicted mean and variance of each acoustic feature associated with the respective target unit. Output layer 904 is further configured to output density weights for each acoustic feature associated with the respective target unit. In some examples, output layer 904 applies a likelihood function that is the linear combination of multiple densities, such as a Gaussian Mixture Model (GMM). In some examples, output layer 904 applies exponential activation functions for the portion of the output layer that generates the variances of acoustic features, and linear activation functions for the portion of the output layer that generates the means of acoustic features.

As discussed above, the plurality of acoustic features include one or more acoustic features, each representing a change in an acoustic feature at a specific portion of the respective target unit. Mixture density network 900 is thus configured to output, at output layer 904, the predicted statistical parameters (e.g., mean and variance) for the change in an acoustic feature at a specific portion of the respective target unit. For example, mixture density network 900 is configured to output, at output layer 904, the mean and variance of the change in fundamental frequency at the end of the respective target unit or the change in each of the mel-frequency cepstral coefficients (e.g., delta mel-frequency cepstral coefficient) at the end of the respective target unit. As discussed, determining the predicted change in one or more acoustic features at the end of a target unit can be desirable as a metric for selecting candidate speech segments that concatenate well, thereby improving the quality and naturalness of the synthesized speech.

It should be recognized that the predicted statistical parameters of a second acoustic feature of the plurality of acoustic features for the respective target unit may not be derived from the predicted statistical parameters of a first acoustic feature of the plurality of acoustic features for the respective target unit. For example, the predicted statistical parameters of the first acoustic feature for the respective target unit may not be used as a starting point to calculate the predicted statistical parameters of the second acoustic feature for the respective target unit. Rather, mixture density network 900 independently determines the predicted statistical parameters of the second acoustic feature for the respective target unit and the predicted statistical parameters of the first acoustic feature for the respective target unit. For example, mixture density network 900 is configured to independently determine the predicted statistical parameters of the delta fundamental frequency at the end of the respective target unit and the predicted statistical parameters of the fundamental frequency at the end of the respective target unit.

Mixture density network 900 is trained based on data that includes recorded speech and a corresponding corpus of text. In some examples, mixture density network 900 is trained in parallel using multiple CPUs. The parallel training scheme can search for an optimal weight space and provide a model faster than sequential training. This model is further retrained on the whole of the data to obtain the final mixture density network that is used at block 706 to determine the predicted statistical parameters for each of a plurality of acoustic features associated with a respective target unit.

At block 708, a plurality of candidate speech segments corresponding to the sequence of target units are selected based on the linguistic features of each target unit. In particular, the plurality of candidate speech segments are selected from a database of speech segments (e.g., database of speech segments 508). The database of speech segments is generated from recorded speech corresponding to a corpus of text. Thus, each candidate speech segment of the plurality of candidate speech segments is a segment (e.g., speech unit, phone, diphone, half-phone, etc.) of the recorded speech. Further, each speech segment includes actual linguistic features (e.g., speech segment position, syllables, syllabic stress, syllable position, phrase length, part of speech, word prominence, etc.) and actual acoustic features (e.g., spectral shape, pitch, duration, Mel-frequency cepstral coefficients, fundamental frequency, etc.). The actual acoustic features of a given candidate speech segment can be represented by a vector x. Additional details of how the database of speech segments is generated are provided below with reference to FIG. 10.

With reference to FIG. 8, candidate speech segments 808 corresponding to sequence of target units 802 is selected from the database of speech segments. The selection of candidate speech segments 808 is based on the linguistic features of each target unit in the sequence of target units 802. Specifically, for each target unit, the database of speech segments is searched to find a corresponding set of candidate speech segments having actual linguistic features that closely match (e.g., a target score that is greater than a predetermined value) the linguistic features of the respective target unit. In the present example shown in FIG. 8, candidate speech segments 808 include a corresponding set of candidate speech segments selected for each target unit. For example, candidate speech segments 808 include five candidate speech segments 809 (including first candidate speech segment 810) selected for first target unit 804 based on the linguistic features of first target unit 804. Candidate speech segments 808 also include four candidate speech segments 811 (including second candidate speech segment 812) selected for second target unit 806 based on the linguistic features of second target unit 806.

At block 710, a target cost is determined for each candidate speech segment of the plurality of candidate speech segments based on the predicted statistical parameters of a first acoustic feature of the plurality of acoustic features associated with a respective target unit of the sequence of target units. For example, with reference to FIG. 8, a target cost is calculated for each of candidate speech segments 808 with respect to the corresponding target unit. Specifically, first target unit 804 is associated with mean and variance parameters of one or more acoustic features (e.g., fundamental frequency, mel-frequency cepstral coefficients, delta fundamental frequency, delta mel-frequency cepstral coefficients, duration, etc.) that were determined at block 706. A target cost is determined for first candidate speech segment 810 based on the mean and variance parameters of the one or more acoustic features associated with first target unit 804. Similarly, second target unit 806 is associated with separate mean and variance parameters of one or more acoustic features (e.g., fundamental frequency, mel-frequency cepstral coefficients, delta fundamental frequency, delta mel-frequency cepstral coefficients, duration, etc.) that were determined at block 706. A target cost is determined for second candidate speech segment 812 based on the mean and variance parameters of the one or more acoustic features associated with second target unit 806.

The target cost for a candidate speech segment indicates how close the actual acoustic features of the candidate speech segment match with the predicted acoustic features of the respective target unit. In some examples, a lower target cost indicates a closer match between the actual acoustic features of the candidate speech segment to the predicted acoustic features of the respective target unit. In some examples, the target cost for each candidate speech segment 808 is the product of Gaussian densities determined using equation (1) shown below. In other examples, in order to achieve a better spacing and resolution, the target cost is the weighted Gaussian negative log-likelihoods determined using equation (2) shown below.

$$\begin{matrix}C = {\prod }_{i} {w}_{i} \frac{1}{√ 2 π {σ}^{2}} exp \{ - \frac{{( {x}_{i} - {μ}_{i} )}^{2}}{2 {σ}_{i}^{2}} \} & ( 1 ) \\ C = {\sum }_{i} {w}_{i} \frac{{( {x}_{i} - {μ}_{i} )}^{2}}{2 {σ}_{i}^{2}} & ( 2 )\end{matrix}$$

In equations (1) and (2), C is the cost, i is the acoustic feature index, wᵢ is a weighting value associated with the respective acoustic feature, xᵢ is the actual acoustic feature of the speech segment, μᵢ is the mean of the acoustic feature of the respective target unit, and σᵢ² is the variance of the acoustic feature of the respective target unit. In a specific example, the target cost is based on the mean and variance of the fundamental frequency at one or more portions of the respective target unit and the duration of the respective target unit. In this example, the target cost defines the prosody of the speech segments.

As indicated in equations (1) and (2), the target cost for a respective candidate speech segment is based on (xᵢ−μᵢ), which is the difference between the actual value of an acoustic feature (xᵢ) for the respective candidate speech segment and the predicted mean of the acoustic feature for the respective target unit. This difference (xᵢ−μᵢ) is weighted by the variance (σᵢ²) of the first acoustic feature for the respective target unit. Thus, the target cost for a respective candidate speech segment is based on the weighted difference (xᵢ−μᵢ)²/2σᵢ². Weighting the difference with the variance (αᵢ²) brings the cost into the probabilistic domain, which results in a more meaningful comparison between the candidate speech segment and the respective target unit. In particular, the target cost for a candidate speech segment represents the likelihood of the candidate speech segment given the acoustic features of the candidate speech segment. The candidate speech segments selected at block 714, based on the target cost for speech synthesis, can thus be more accurate, thereby resulting in more natural sounding speech.

At block 712, a plurality of concatenation costs for each candidate speech segment of the plurality of candidate speech segments are determined with respect to a plurality of subsequent candidate speech segments. The plurality of concatenation costs are determined based on the predicted statistical parameters of a second acoustic feature of the plurality of acoustic features associated with the respective target unit of the sequence of target units. For example, each concatenation cost is based on the mean and variance of the delta fundamental frequency (delta pitch) and/or the delta mel-frequency cepstral coefficients at a specific portion of the respective target unit (e.g., at the end of the respective target unit).

Returning to the example of FIG. 8, concatenation costs are determined for each of candidate speech segments 808 with respect to one or more subsequent candidate speech segments of candidate speech segment 808. Specifically, for first candidate speech segment 810, a concatenation cost is determined for each subsequent candidate speech segment (e.g., candidate speech segments 811) corresponding to the subsequent target unit (e.g., second target unit 806). Thus, for first candidate speech segment 810, separate concatenation costs are determined with respect to each of candidate speech segments 811. Therefore, every connection (e.g., connection 814 or 817) joining every consecutive pair of candidate speech segments (first candidate speech segment 810 and second candidate speech segment 812) in candidate speech segments 808 is associated with a concatenation cost.

The concatenation cost for a candidate speech segment with respect to a subsequent candidate speech segment indicates how close the actual concatenation of the pair of candidate speech segments matches with the predicted concatenation of the respective target unit with respect to the subsequent target unit. In some examples, a lower concatenation cost indicates a closer match between the actual concatenation of the candidate speech segment with the subsequent candidate speech segment and the predicted concatenation of the respective target unit with the subsequent target unit.

As discussed above, first target unit 804 is associated with the means and variances of one or more acoustic features (e.g., fundamental frequency, mel-frequency cepstral coefficients, delta fundamental frequency, delta mel-frequency cepstral coefficients, duration, etc.) that were determined at block 706. The concatenation costs determined for first candidate speech segment 810 are based on the means and variances of the one or more acoustic features associated with first target unit 804. Similarly, second target unit 806 is associated with means and variances of one or more acoustic features (e.g., fundamental frequency, mel-frequency cepstral coefficients, delta fundamental frequency, delta mel-frequency cepstral coefficients, duration, etc.) that were determined at block 706. The concatenation costs determined for second candidate speech segment 812 are based on the means and variances of the one or more acoustic features associated with second target unit 806.

In some examples, each concatenation cost is the product of Gaussian densities determined using equation (1) described above or the weighted Gaussian negative log-likelihoods determined using equation (2) described above. Similar to the target cost, the concatenation cost for a candidate speech segment with respect to a subsequent candidate speech segment is based on (xᵢ−μᵢ), which is the difference between the actual value of an acoustic feature (xᵢ) for the candidate speech segment with respect to the subsequent candidate speech segment and the predicted mean of the acoustic feature for the respective target unit. In one example, the actual value of the acoustic feature for the candidate speech segment with respect to the subsequent candidate speech segment is the difference between an actual value of the first acoustic feature at an end of the candidate speech segment and an actual value of the first acoustic feature at a beginning of the subsequent candidate speech segment. For example, the concatenation cost for first candidate speech segment 810 with respect to second candidate speech segment 812 is based on the difference between the actual delta fundamental frequency at the end of first candidate speech segment 810 and the predicted mean of the delta fundamental frequency at the end of first target unit 804. The actual delta fundamental frequency at the end of first candidate speech segment 810 is the difference between the actual fundamental frequency at the end of first candidate speech segment 810 and the actual fundamental frequency at the beginning of second candidate speech segment 812.

Further, the difference (xᵢ−μᵢ) is weighted by the variance (σ²) of the first acoustic feature for the respective target unit. For example, the difference between the actual delta fundamental frequency at the end of first candidate speech segment 810 and the predicted mean of the delta fundamental frequency at the end of first target unit 804 is weighted by the predicted variance of the delta fundamental frequency at the end of first target unit 804. Thus, the concatenation cost for a respective candidate speech segment is based on the weighted difference (xᵢ−μᵢ)²/2σᵢ². As discussed above, weighting the difference with the variance (σᵢ²) brings the cost into the probabilistic domain, which results in a more meaningful comparison between the candidate speech segment and the respective target unit. In particular, the concatenation cost for a pair of candidate speech segments represents the likelihood of the subsequent candidate speech segment succeeding the candidate speech segment given the acoustic parameters of the candidate speech segment with respect to the subsequent candidate speech segment. The candidate speech segments selected based on the concatenation cost at block 714 for speech synthesis can thus be more accurate, thereby resulting in more natural sounding speech.

At block 714, a subset of candidate speech segments is selected from the plurality of candidate speech segments for speech synthesis. The selecting at block 714 is based on a combined cost associated with the subset of candidate speech segments. The combined cost is determined based on the target costs of each candidate speech segment (determined at block 710) and the concatenation costs of each candidate speech segment with respect to subsequent candidate speech segments (determined at block 712).

The selecting of the subset of candidate speech segments is based on a Viterbi search to determine the sequence of candidate speech segments having the lowest combined cost. For example, with reference to FIG. 8, candidate speech segments 808 form a Viterbi search lattice where each candidate speech segment is associated with a target cost and each connection between pairs of consecutive speech segments is associated with a concatenation cost. Each path through the Viterbi search lattice represents a possible sequence of candidate speech segments that can be joined to synthesize the phrase “closet.” Further, each path is associated with a combined cost that is based on the target costs of the candidate speech segments and the concatenation costs of the corresponding connections associated with the respective path. In some examples, different weighting factors are applied to the target costs and the concatenation costs to determine the combined cost for a given path through the Viterbi search lattice. The path associated with the lowest combined cost is selected and the sequence of candidate speech segments corresponding to the selected path is used to synthesize speech. For example, in FIG. 8, path 820 indicated in bold is determine to have the lowest combined cost among all the possible paths through the Viterbi search lattice and thus the sequence of candidate speech segments associated with path 820 is selected for speech synthesis at block 714.

At block 716, speech corresponding to the received text is generated using the subset of candidate speech segments. For example, the sequence of candidate speech segment corresponding to path 820 in FIG. 8 can be joined together to form a continuous speech waveform representing the spoken form of the received text “closet.” In addition, various signal processing methods known in the art can be implemented to achieve a smooth speech audio waveform. In some examples, the generated speech is in the form of an audio signal representing the spoken form of the text received at block 702. Alternatively, the generated speech is an audio file (e.g., .wav, .mp3, .wma, etc.) representing the spoken form of the text received at block 702. In some examples, the generated speech is outputted to the user. For example, the generated speech at block 716 is outputted via a speaker (e.g., speaker 111) of the device.

FIG. 10 illustrates a flow diagram of exemplary process 1000 for generating a database of speech segments for use in unit-selection text-to-speech synthesis in accordance with some embodiments. Process 1000 can be performed using one or more of devices 100, 300, and 1100 (FIGS. 1A, 2, 3A-B, and 11). In particular, process 1100 can be performed using a speech segment generation module (e.g., speech segment generation module 600 of FIG. 6), implemented on the one or more devices. It should be appreciated that some operations in process 1000 can be combined, the order of some operations can be changed, and some operations can be omitted.

At block 1002, recorded speech corresponding to a corpus of text is obtained. The recorded speech is spoken by a single person, such as a voice talent. Specifically, the recorded speech is a reading of the corpus of text by the voice talent. In some examples, the recorded speech contains several hours (e.g., 3-5 hours or 5-10 hours) of recorded speech. The recorded speech includes some deviations from the corpus of text. Allowing for deviations enables the voice talent to read the corpus of text in a more natural manner, which results in more natural-sounding speech segments for speech synthesis.

At block 1004, a custom language model is built from the corpus of text. The language model is, for example, an n-gram language model. Block 1004 is performed by a language model generator module (e.g., language model generation module 602). By training the language model using the corpus of text itself, the language model is optimized for determining words and phrases found in the corpus of text.

At block 1006, speech-to-text conversion of the recorded speech is performed using the language model of block 1004 to obtain speech recognition results corresponding to the recorded speech. Block 1006 can be performed using an automatic speech recognition module (e.g., automatic speech recognition module 604). Because the language model is trained using the corpus of text, the accuracy of the speech recognition results is improved as compared to using a generic language model trained using a general corpus of text.

At block 1008, portions of the corpus of text where the speech recognition results do not match with the corpus of text are extracted out. In particular, the speech recognition results are compared to the corpus of text to identify any mismatches. Mismatches include any portion of the speech recognition results having different words, missing words, or added words with respect to the corpus of text. Mismatches also include words in the speech recognition results associated with a poor confidence score (e.g., lower than a predetermined threshold). The portions of the corpus of text that correspond to the mismatches of the speech recognition results are extracted out. Further, at block 1010, portions of recorded speech that correspond to the extracted portions of the corpus of text in block 1008 are extracted out from the recorded speech. The collection of portions of the corpus of text and corresponding portions of recorded speech obtained at blocks 1008 and 1010 is stored. Blocks 1008 and 1010 can be performed using a verification module (e.g., verification module 606).

At block 1012, corrected portions of the corpus of text and corrected portions of recorded speech are received. The corrected portions of the corpus of text and the corrected portions of recorded speech are based on the portions of the corpus of text and corresponding portions of recorded speech obtained at blocks 1008 and 1010. For example, the portions of the corpus of text and corresponding portions of recorded speech obtained at blocks 1008 and 1010 are sent to a crowdsourcing service to correct and/or verify each portion of recorded speech with the corresponding portion of the corpus of text. In these examples, the corrected portions of the corpus of text and the corrected portions of recorded speech are received from the crowdsourcing service. Other methods can alternatively be implemented to correct and/or verify the portions of the corpus of text and the corresponding portions of recorded speech. For example, the corresponding portions of recorded speech are processed using more robust speech-to-text algorithms and models, and the results are compared to the corresponding portions of the corpus of text.

By verifying only the portions of the corpus of text and recorded speech where the speech recognition results do not match with the corpus of text (rather than the entire corpus of text and/or the entire recorded speech), the recorded speech and corpus of text are verified more quickly and efficiently. The recorded speech and/or the corpus of text are modified (e.g., using verification module 606) based on the corrected portions of speech recognition results and the corrected portions of recorded speech to obtain verified recorded speech and a verified corpus of text.

At block 1014, labeled speech segments are generated based on the recorded speech, the corpus of text, the corrected portions of the corpus of text, and the corrected portions of recorded speech. In particular, the label speech segments are generated based on the verified recorded speech and the verified corpus of text of block 1012.

For example, the verified recorded speech and the verified recorded speech are processed (e.g., using automatic speech recognition module 604) to force-align the verified recorded speech to the verified corpus of text and segment the verified recorded speech into speech segments (e.g., speech segments, phones, sub-phones, etc.). Each of the speech segments is labeled (e.g., using voice building module 610) to indicate the identity of the speech segment (e.g., the particular phone or sub-phone) and the linguistic features associated with the speech segment. Further, each speech segment is analyzed (e.g., using feature generation module 608) to determine the acoustic features associated with the respective speech segment. The determined acoustic features include, for example, fundamental frequency, mel-frequency cepstral coefficient, pitch, duration, or the like. In particular, determining the fundamental frequency of a speech segment can require pitch extraction processes. In some examples, several fundamental frequency estimation methods known in the art are implemented in a voting scheme that forms a robust fundamental frequency curve. The fundamental frequency curve is used in pitch marking to derive the pseudo-glottal closure instant locations. The fundamental frequency of a speech segment is thus determined based on the derived pseudo-glottal closure instant locations.

Each speech segment is labeled (e.g., using voice building module 610) to indicate the acoustic features of the speech segment. At block 1016, the labeled speech segments of block 1014 are stored in an indexed speech segment database (e.g., speech segment database 508). Speech segments are thus searched and retrieved based on their identity (e.g., the specific phone or sub-phone), their linguistic features, or their acoustic features.

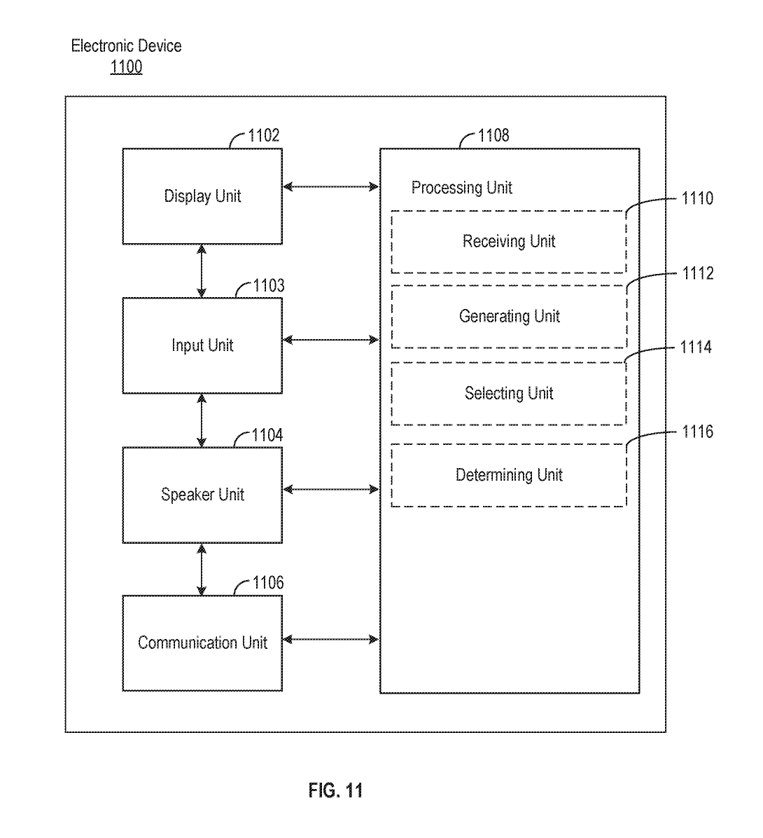

In accordance with some embodiments, FIG. 11 shows a functional block diagram of an electronic device 1100 configured in accordance with the principles of the various described embodiments, including those described with reference to FIG. 7. The functional blocks of the device are, optionally, implemented by hardware, software, or a combination of hardware and software to carry out the principles of the various described embodiments. It is understood by persons of skill in the art that the functional blocks described in FIG. 11 are, optionally, combined or separated into sub-blocks to implement the principles of the various described embodiments. Therefore, the description herein optionally supports any possible combination or separation or further definition of the functional blocks described herein.

As shown in FIG. 11, electronic device 1100 includes input unit 1103 configured to receive user input, such as text input, speaker unit 1104 configured to output speech, and communication unit 1106 configured to send and receive information (e.g., text) from external devices via a network. In some examples, electronic device 1100 optionally includes a display unit 1102 configured to display objects or text and receive touch/gesture input. Electronic device 1100 further includes processing unit 1108 coupled to input unit 1103, speaker unit 1104, communication unit 1106, and optionally display unit 1102. In some examples, processing unit 1108 includes receiving unit 1110, generating unit 1112, selecting unit 1114, and determining unit 1116.

In accordance with some embodiments, processing unit 1108 is configured to receive (e.g., with receiving unit 1110) text to be converted to speech. The text is received via one of display unit 1102, input unit 1103, or communication unit 1106. Processing unit 1108 is further configured to generate (with generating unit 1112) a sequence of target units representing a spoken pronunciation of the text. Processing unit 1108 is further configured to determine (e.g., with determining unit 1116, based on a plurality of linguistic features associated with each target unit of the sequence of target units, predicted statistical parameters for each of a plurality of acoustic features associated with each target unit. Processing unit 1108 is further configured to select (e.g., with selecting unit 1114), based on the plurality of linguistic features associated with each target unit, a plurality of candidate speech segments corresponding to the sequence of target units. Processing unit 1108 is further configured to determine (e.g., with determining unit 1116) a target cost for each candidate speech segment of the plurality of candidate speech segments, based on the predicted statistical parameters of a first acoustic feature of the plurality of acoustic features associated with a respective target unit of the sequence of target units. Processing unit 1108 is further configured to determine (e.g., with determining unit 1116) a plurality of concatenation costs with respect to a plurality of subsequent candidate speech segments for each candidate speech segment of the plurality of candidate speech segments. The plurality of concatenation costs is determined (e.g., with determining unit 1116) based on the predicted statistical parameters of a second acoustic feature of the plurality of acoustic features associated with the respective target unit of the sequence of target units. Processing unit 1108 is further configured to select (e.g., with selecting unit 1114) from the plurality of candidate speech segments a subset of candidate speech segments for speech synthesis. The selecting (with selecting unit 1114) is based on a combined cost associated with the subset of candidate speech segments. The combined cost is determined based on the target cost and the plurality of concatenation costs of each candidate speech segment. Processing unit 1108 is further configured to generate (e.g., with generating unit 1112) speech corresponding to the received text using the subset of candidate speech segments.

In some examples, the second acoustic feature represents a change of the first acoustic feature. In some examples, the change of the first acoustic feature is with respect to an end of the respective target unit. In some examples, the first acoustic feature comprises pitch and the second acoustic feature comprises a change in the pitch at an end of the respective target unit. In some examples, the first acoustic feature comprises a mel-frequency cepstral coefficient and the second acoustic feature comprises a change in the mel-frequency cepstral coefficient at an end of the respective target unit. In some examples, the plurality of acoustic features includes a pitch at a first portion of the respective target unit and a pitch at a second portion of the respective target unit. In some examples, the plurality of acoustic features includes a first plurality of mel-frequency cepstral coefficients at a first portion of the respective target unit and a second plurality of mel-frequency cepstral coefficients at a second portion of the respective target unit. In some examples, the plurality of acoustic features includes a duration of the respective target unit.

In some examples, the predicted statistical parameters of the second acoustic feature are not derived from the predicted statistical parameters of the first acoustic feature. In some examples, the predicted statistical parameters for each of the plurality of acoustic features include a mean parameter for each of the plurality of acoustic features and a variance parameter for each of the plurality of acoustic features.

In some examples, the target cost for a respective candidate speech segment is based on a weighted difference between an actual value of the first acoustic feature for the respective candidate speech segment and a first predicted statistical parameter of the predicted statistical parameters of the first acoustic feature for the respective target unit. The weighted difference is weighted by a second predicted statistical parameter of the predicted statistical parameters of the first acoustic feature for the respective target unit.

In some examples, a concatenation cost of the plurality of concatenation costs for a respective candidate speech segment includes a second weighted difference between an actual value of the second acoustic feature for the respective candidate speech segment with respect to a subsequent candidate speech segment of the plurality of subsequent candidate speech segments and a first predicted statistical parameter of the predicted statistical parameters of the second acoustic feature for the respective target unit, and wherein the second weighted difference is weighted by a second predicted statistical parameter of the predicted statistical parameters of the second acoustic feature for the respective target unit.

In some examples, the actual value of the second acoustic feature for the respective candidate speech segment with respect to the subsequent candidate speech segment of the plurality of subsequent candidate speech segments comprises a difference between an actual value of the first acoustic feature at an end of the respective candidate speech segment and an actual value of the first acoustic feature at a beginning of the subsequent candidate speech segment. In some examples, the plurality of candidate speech segments each comprise a segment of recorded speech.

In some examples, the predicted statistical parameters for each of the plurality of acoustic features associated with each target unit are determined using a statistical model. In some examples, the statistical model is composed by a mixture of probability distributions.

In some examples, the statistical model is configured to receive, as inputs, the plurality of linguistic features associated with a respective target unit and to output the predicted statistical parameters for each of the plurality of acoustic features associated with the respective target unit. The statistical model is further configured to output one or more density weights for each of the plurality of acoustic features associated with the respective target unit.

In some examples, the statistical model is a mixture density network comprising an input layer configured to receive as inputs the plurality of linguistic features associated with a respective target unit, an output layer configured to output the predicted statistical parameters for each of the plurality of acoustic features associated with the respective target unit, and at least one hidden layer between the input layer and the output layer. In some examples, the mixture density network is a recurrent mixture density network.

In some examples, the statistical model is configured to determine, for each target unit, the predicted statistical parameters of the second acoustic feature independent of the predicted statistical parameters of the first acoustic feature. In some examples, the statistical model is generated based on recorded speech corresponding to a corpus of text.

In some examples, the plurality of candidate speech segments is selected from a collection of speech segments. Processing unit 1108 is further configured to generate (e.g., with generating unit 1112) the collection of speech segments. In some examples, generating unit 1112 is further configured to obtain recorded speech corresponding to a corpus of text. Generating unit 1112 is further configured to generate a language model from the corpus of text. Generating unit 1112 is further configured to perform speech-to-text conversion of the recorded speech using the language model to obtain speech recognition results corresponding to the recorded speech. Generating unit 1112 is further configured to extract portions of the corpus of text where the speech recognition results do not match with the corpus of text. Generating unit 1112 is further configured to extract portions of recorded speech corresponding to the portions of the corpus of text. Generating unit 1112 is further configured to receive corrected portions of the corpus of text and corrected portions of the recorded speech. The corrected portions of the corpus of text and the corrected portions of the recorded speech are based on the portions of the corpus of text and the portions of recorded speech. Generating unit 1112 is further configured to generate labeled speech segments based on the recorded speech, the corpus of text, the corrected portions of the corpus of text, and the corrected portions of the recorded speech. The collection of speech segments is generated from the labeled speech segments.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods described herein.

In accordance with some implementations, an electronic device (e.g., a multifunctional device) is provided that comprises means for performing any of the methods described herein.

In accordance with some implementations, an electronic device (e.g., a multifunctional device) is provided that comprises a processing unit configured to perform any of the methods described herein.

In accordance with some implementations, an electronic device (e.g., a multifunctional device) is provided that comprises one or more processors and memory storing one or more programs for execution by the one or more processors, the one or more programs including instructions for performing any of the methods described herein.

The operation described above with respect to FIG. 7 is, optionally, implemented by components depicted in FIGS. 1A-B, 3, 5, and 11. For example, receiving operation 702 and generating operation 704 can be implemented by text analysis module 502. Selecting operations 708, 714 and determining operations 706, 710, 712 can be implemented by unit-selection module 504, acoustic feature prediction model(s) 506, and speech segment database 508. Generating operation 716 can be implemented by speech synthesizer module 510. It would be clear to a person of ordinary skill in the art how other processes can be implemented based on the components depicted in FIGS. 1A-B, 3, 5, and 11.

It is understood by persons of skill in the art that the functional blocks described in FIG. 11 are, optionally, combined or separated into sub-blocks to implement the principles of the various described embodiments. Therefore, the description herein optionally supports any possible combination or separation or further definition of the functional blocks described herein. For example, processing unit 1108 can have an associated “controller” unit that is operatively coupled with processing unit 1108 to enable operation. This controller unit is not separately illustrated in FIG. 11 but is understood to be within the grasp of one of ordinary skill in the art who is designing a device having a processing unit 1108, such as device 1100. As another example, one or more units, such as receiving unit 1110, may be hardware units outside of processing unit 1108 in some embodiments. The description herein thus optionally supports combination, separation, and/or further definition of the functional blocks described herein.

Executable instructions for performing the functions and processes described herein are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the appended claims.

What is claimed is:

1. A system for unit-selection text-to-speech synthesis, the system comprising:
one or more processors; and
memory storing one or more programs, wherein the one or more programs include instructions which, when executed by the one or more processors, cause the one or more processors to:
receive text to be converted to speech;
generate a sequence of target units representing a spoken pronunciation of the text;
determine, based on a plurality of linguistic features associated with each target unit of the sequence of target units, predicted statistical parameters for each of a plurality of acoustic features associated with each target unit;
select, based on the plurality of linguistic features associated with each target unit, a plurality of candidate speech segments corresponding to the sequence of target units;
for each candidate speech segment of the plurality of candidate speech segments:
determine a target cost based on the predicted statistical parameters of a first acoustic feature of the plurality of acoustic features associated with a respective target unit of the sequence of target units; and
determine a plurality of concatenation costs with respect to a plurality of subsequent candidate speech segments, the plurality of concatenation costs determined based on the predicted statistical parameters of a second acoustic feature of the plurality of acoustic features associated with the respective target unit of the sequence of target units;
select from the plurality of candidate speech segments a subset of candidate speech segments for speech synthesis, the selecting based on a combined cost associated with the subset of candidate speech segments, wherein the combined cost is determined based on the target cost and the plurality of concatenation costs of each candidate speech segment; and
generate speech corresponding to the received text using the subset of candidate speech segments.

2. The system of claim 1, wherein the second acoustic feature represents a change of the first acoustic feature.

3. The system of claim 2, wherein the change of the first acoustic feature is with respect to an end of the respective target unit.

4. The system of claim 1, wherein the first acoustic feature comprises fundamental frequency and the second acoustic feature comprises a change in the fundamental frequency at an end of the respective target unit.

5. The system of claim 1, wherein the first acoustic feature comprises a mel-frequency cepstral coefficient and the second acoustic feature comprises a change in the mel-frequency cepstral coefficient at an end of the respective target unit.

6. The system of claim 1, wherein the plurality of acoustic features include a fundamental frequency at a first portion of the respective target unit and a fundamental frequency at a second portion of the respective target unit.

7. The system of claim 1, wherein the plurality of acoustic features includes a first plurality of mel-frequency cepstral coefficients at a first portion of the respective target unit and a second plurality of mel-frequency cepstral coefficients at a second portion of the respective target unit.

8. The system of claim 1, wherein the plurality of acoustic features includes a duration of the respective target unit.

9. The system of claim 1, wherein the predicted statistical parameters of the second acoustic feature is not derived from the predicted statistical parameters of the first acoustic feature.

10. The system of claim 1, wherein the predicted statistical parameters for each of the plurality of acoustic features include a mean parameter for each of the plurality of acoustic features and a variance parameter for each of the plurality of acoustic features.

11. The system of claim 1, wherein the target cost for a respective candidate speech segment is based on a weighted difference between an actual value of the first acoustic feature for the respective candidate speech segment and a first predicted statistical parameter of the predicted statistical parameters of the first acoustic feature for the respective target unit, and wherein the weighted difference is weighted by a second predicted statistical parameter of the predicted statistical parameters of the first acoustic feature for the respective target unit.

12. The system of claim 1, wherein a concatenation cost of the plurality of concatenation costs for a respective candidate speech segment includes a second weighted difference between an actual value of the second acoustic feature for the respective candidate speech segment with respect to a subsequent candidate speech segment of the plurality of subsequent candidate speech segments and a first predicted statistical parameter of the predicted statistical parameters of the second acoustic feature for the respective target unit, and wherein the second weighted difference is weighted by a second predicted statistical parameter of the predicted statistical parameters of the second acoustic feature for the respective target unit.

13. The system of claim 12, wherein the actual value of the second acoustic feature for the respective candidate speech segment with respect to the subsequent candidate speech segment of the plurality of subsequent candidate speech segments comprises a difference between an actual value of the first acoustic feature at an end of the respective candidate speech segment and an actual value of the first acoustic feature at a beginning of the subsequent candidate speech segment.

14. The system of claim 1, wherein the predicted statistical parameters for each of the plurality of acoustic features associated with each target unit are determined using a statistical model.

15. The system of claim 14, wherein the statistical model is composed by a mixture of probability distributions.

16. The system of claim 14, wherein the statistical model is configured to:
receive, as inputs, the plurality of linguistic features associated with a respective target unit; and
output the predicted statistical parameters for each of the plurality of acoustic features associated with the respective target unit.

17. The system of claim 16, wherein the statistical model is further configured to output one or more density weights for each of the plurality of acoustic features associated with the respective target unit.

18. The system of claim 14, wherein the statistical model is a mixture density network comprising:
an input layer configured to receive as inputs the plurality of linguistic features associated with a respective target unit;
an output layer configured to output the predicted statistical parameters for each of the plurality of acoustic features associated with the respective target unit; and
at least one hidden layer between the input layer and the output layer.

19. The system of claim 14, wherein the statistical model is configured to determine, for each target unit, the predicted statistical parameters of the second acoustic feature independent of the predicted statistical parameters of the first acoustic feature.

20. A method for unit-selection text-to-speech synthesis, comprising:
at an electronic device having a processor and memory:
receiving text to be converted to speech;
generating a sequence of target units representing a spoken pronunciation of the text;
determining, based on a plurality of linguistic features associated with each target unit of the sequence of target units, predicted statistical parameters for each of a plurality of acoustic features associated with each target unit;
selecting, based on the plurality of linguistic features associated with each target unit, a plurality of candidate speech segments corresponding to the sequence of target units;
for each candidate speech segment of the plurality of candidate speech segments:
determining a target cost based on the predicted statistical parameters of a first acoustic feature of the plurality of acoustic features associated with a respective target unit of the sequence of target units; and
determining a plurality of concatenation costs with respect to a plurality of subsequent candidate speech segments, the plurality of concatenation costs determined based on the predicted statistical parameters of a second acoustic feature of the plurality of acoustic features associated with the respective target unit of the sequence of target units;
selecting from the plurality of candidate speech segments a subset of candidate speech segments for speech synthesis, the selecting based on a combined cost associated with the subset of candidate speech segments, wherein the combined cost is determined based on the target cost and the plurality of concatenation costs of each candidate speech segment; and
generating speech corresponding to the received text using the subset of candidate speech segments.

21. The method of claim 20, wherein the second acoustic feature represents a change of the first acoustic feature.

22. The method of claim 20, wherein the target cost for a respective candidate speech segment is based on a weighted difference between an actual value of the first acoustic feature for the respective candidate speech segment and a first predicted statistical parameter of the predicted statistical parameters of the first acoustic feature for the respective target unit, and wherein the weighted difference is weighted by a second predicted statistical parameter of the predicted statistical parameters of the first acoustic feature for the respective target unit.

23. The method of claim 20, wherein a concatenation cost of the plurality of concatenation costs for a respective candidate speech segment includes a second weighted difference between an actual value of the second acoustic feature for the respective candidate speech segment with respect to a subsequent candidate speech segment of the plurality of subsequent candidate speech segments and a first predicted statistical parameter of the predicted statistical parameters of the second acoustic feature for the respective target unit, and wherein the second weighted difference is weighted by a second predicted statistical parameter of the predicted statistical parameters of the second acoustic feature for the respective target unit.

24. The method of claim 23, wherein the actual value of the second acoustic feature for the respective candidate speech segment with respect to the subsequent candidate speech segment of the plurality of subsequent candidate speech segments comprises a difference between an actual value of the first acoustic feature at an end of the respective candidate speech segment and an actual value of the first acoustic feature at a beginning of the subsequent candidate speech segment.

25. A non-transitory computer-readable storage medium comprising computer-readable instructions which, when executed by one or more processors, cause the one or more processors to:
receive text to be converted to speech;
generate a sequence of target units representing a spoken pronunciation of the text;
determine, based on a plurality of linguistic features associated with each target unit of the sequence of target units, predicted statistical parameters for each of a plurality of acoustic features associated with each target unit;
select, based on the plurality of linguistic features associated with each target unit, a plurality of candidate speech segments corresponding to the sequence of target units;
for each candidate speech segment of the plurality of candidate speech segments:
determine a target cost based on the predicted statistical parameters of a first acoustic feature of the plurality of acoustic features associated with a respective target unit of the sequence of target units; and
determine a plurality of concatenation costs with respect to a plurality of subsequent candidate speech segments, the plurality of concatenation costs determined based on the predicted statistical parameters of a second acoustic feature of the plurality of acoustic features associated with the respective target unit of the sequence of target units;
select from the plurality of candidate speech segments a subset of candidate speech segments for speech synthesis, the selecting based on a combined cost associated with the subset of candidate speech segments, wherein the combined cost is determined based on the target cost and the plurality of concatenation costs of each candidate speech segment; and
generate speech corresponding to the received text using the subset of candidate speech segments.
